(19) United States
(12) Patent Application Publication
(10) Pub. No.: US 2025/0384623 A1
(43) Pub. Date: Dec. 18, 2025

(54) Diffusion Model for Real Time Interactive Inference

(71) Applicant: Advanced Micro Devices, Inc., Santa Clara, CA (US)

(72) Inventors: Michael Burrows, Redmond, WA (US); Kunal Tyagi, Ichikawa (JP); Pedro Antonio Pena, Orlando, FL (US); SungYe Kim, Folsom, CA (US); Rama Sharma Bangalore Harihara, San Jose, CA (US)

(21) Appl. No.: 18/988,263

(22) Filed: Dec. 19, 2024

Related U.S. Application Data
(60) Provisional application No. 63/658,931, filed on Jun. 12, 2024.

(51) Int. Cl. G06T 15/60; G06T 3/40; G06T 7/70; G06T 13/40; G06T 15/04

(52) U.S. Cl. CPC G06T 15/60; G06T 3/40; G06T 7/70; G06T 13/40; G06T 15/04

(57) ABSTRACT

An apparatus and method for efficiently performing efficient video processing that provides visual fidelity with changes in lighting and animation details. In various implementations, a computing system includes multiple processing circuits executing a variety of types of machine learning (ML) data models according to a particular architecture to implement a generative artificial intelligence (Gen AI) model. The Gen AI model receives input image data and generates an output image while reducing the amount of real-time data to transfer from a host processing circuit to other processing circuits. The Gen AI model performs rendering operations on the input low level of detail objects at a low resolution in panoramic mode. The multiple processing circuits execute a first subset of video processing tasks at a rate of every frame, whereas other processing circuits execute a second subset of video processing tasks at a rate less than each video frame.

### CROSS REFERENCE TO RELATED APPLICATIONS

This application claims priority to Provisional Patent Application Ser. No. 63/658,931, entitled “DIFFUSION MODEL FOR REAL TIME INTERACTIVE INFERENCE,” filed Jun. 12, 2024, the entirety of which is incorporated herein by reference.

### BACKGROUND

### Description of the Relevant Art

Video processing methods are complex and include many different functions. Computing systems use advanced processors to satisfy the high computation demands. The video processing complexity increases as the resolution of display devices increases and the refresh rate of display devices increases. Additionally, video processing becomes more complex as the available data bandwidth decreases and the processing occurs in real-time. Further, video processing products can include streaming services, which are services that provide real-time presentation of content on a user's remote computing device where the content is updated in real-time based on user input. The content stored on remote servers is accessed through a network by the user's computing device such as a laptop computer, desktop computer, or other.

In addition to video game (or gaming) products, real-time video processing occurs for displaying three-dimensional (3D) objects in a variety of video processing products for other fields such as biomedicine, urban planning, education, marketing, architecture, filmmaking, engineering, and so forth. These video processing products can offer complex surface details of 3D models of objects. Additionally, these video processing products provide 3D animation of characters and objects. In some cases, generative artificial intelligence models are being used to generate new content, such as images and videos. They use deep learning algorithms and neural networks to identify patterns and generate new outcomes. Depending on the application and its use, these 3D objects can be an avatar or a character of a video game or an educational presentation or a marketing presentation. These 3D objects can also be a human organ or a group of organs for a medical instructional presentation, a vehicle or moving components of vehicle subsystems in an engineering design simulation, and so on.

For a more appealing experience and better conveyance of information, users of the video processing application desire high visual fidelity. In order to provide such an experience, objects with a high level of detail (LOD) can be used. However, using the high LOD objects places significant demands on the memory and processing systems. To reduce these demands, reductions in visual fidelity, temporal coherence, and lack of updates using panoramic information and lighting effects are used as tradeoffs. Both the user experience and conveyance of information suffer as a result.

In view of the above, efficient methods and apparatuses for performing efficient video processing that provides visual fidelity with changes in lighting and animation details are desired.

### BRIEF DESCRIPTION OF THE DRAWINGS

FIG. 1 is a generalized diagram of a computing system that performs efficient video processing that provides visual fidelity with changes in lighting and animation details.

FIG. 2 is a generalized diagram of a video processing flow that performs efficient video processing that provides visual fidelity with changes in lighting and animation details.

FIG. 3 is a generalized diagram of a computing system that performs efficient video processing that provides visual fidelity with changes in lighting and animation details.

FIG. 4 is a generalized diagram of a generative artificial intelligence rendering architecture that performs efficient video processing that provides visual fidelity with changes in lighting and animation details.

FIG. 5 is a generalized diagram of a computing system that performs efficient video processing that provides visual fidelity with changes in lighting and animation details.

FIG. 6 is a generalized diagram of a method for performing efficient video processing that provides visual fidelity with changes in lighting and animation details.

FIG. 7 is a generalized diagram of a method for performing efficient video processing that provides visual fidelity with changes in lighting and animation details.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient video processing that provides visual fidelity with changes in lighting and animation details are disclosed. In various implementations, a computing system includes a computing device with multiple processing circuits connected to a display device. The circuitry of the processing circuits executes instructions of a video processing application that uses three-dimensional (3D) animation of objects to be presented to the user on the display device. The video processing application provides multiple input images of a video sequence, each with a scene. The video sequence includes animation as well as environmental visual effects portrayed across the scenes. To improve the visual quality of objects while using low level of detail (LOD) objects of the video processing application to represent high LOD objects, methods and systems are disclosed that generate the high LOD object that includes high visual fidelity even with changes in lighting and animation details. To generate, from input image data received from the video processing application, an output image with high visual fidelity, in various implementations, the multiple processing circuits execute a variety of types of machine learning (ML) data models according to a particular architecture to implement a generative artificial intelligence (Gen AI) model.

The Gen AI model receives input image data and generates the output image while reducing the amount of real-time data to transfer from a host processing circuit to other processing circuits. An example of the host processing circuit is a general-purpose processing circuit, such as a central processing unit (CPU). Reducing the amount of real-time data to transfer reduces the demand on the memory and processing subsystems. Additionally, the Gen AI model performs rendering operations on the input low LOD objects of the scene at a low resolution, which reduces the processing demand on processing circuits. Further, the Gen AI model performs these operations in a panoramic mode, which allows for shadows or reflections in windows, water or mirrors to be seen in a scene from objects not in the field of view of the source such as the camera's point of view.

Furthermore, the Gen AI model generates a first portion of the display image at a first data processing rate where the first portion does not include the most-recent environmental lighting effects updates. The Gen AI model generates a second portion of the display image at a second data processing rate less than the first data processing rate where the second portion includes environmental lighting effects updates from a prior scene of the video sequence. Using the second data processing rate and neural network encoded vectors of one or more objects with pre-encoded style characteristics, the processing circuits provide high visual fidelity objects despite beginning with low LOD objects. Yet further, the Gen AI model selects a subset of objects as points of interest to provide further video processing, which reduces the demand of providing these steps to the entire scene.

Typically, to provide high visual fidelity of animated display images, video processing systems require the host processing circuit to send high LOD representations of objects to at least a parallel data processing circuit in real-time. This real-time data transfer places high computation demands on the processing circuits and places high memory bandwidth demands on the memory subsystem and data buses. Typically, video processing systems do not use raster and rendering operations in a panoramic mode, so details of shadows and reflections of objects not directly in the scene are lost. Typically, video processing systems operate at a single high data processing rate for all processing circuits, which causes the least supportive processing circuit of a higher data processing rate to bottleneck the entire video processing system.

To avoid the computing issues of typical video processing systems, the host processing circuit provides low detail polygon mesh representations of objects in the scene to another processing circuit such as a parallel data processing circuit. A first polygon count of the low level of detail (LOD) polygon mesh representation of the one or more objects received by the generative artificial intelligence model is less than a second polygon count of a high LOD representation of the one or more objects of the output image. As used herein, the terms “low” and “high” are merely intended to indicate one object has lower or higher detail than the other. In other words, these terms are intended to indicate relative levels of detail. The level of detail used for each of the low LOD object and the high LOD object can vary.

While supporting the implementation of the Gen AI model, the host processing circuit also provides both user input information and application input information to the parallel data processing circuit. The user input information includes user controls that indicate movement of a character or avatar. The application input information includes indications of environment information such as weather conditions for a scene depicting an outdoor image and complex lighting effects. The combination of the low detail polygon mesh representation of objects, the user input information, and the application input information reduces the amount of real-time data to transfer, which reduces the data transfer bandwidth demand on the memory and processing subsystems.

One or more of the parallel data processing circuit and other processing circuits perform raster and rendering operations on the input low LOD objects of the scene at a low resolution in panoramic mode. Examples of these processing circuits are a graphics processing unit (GPU), a digital signal processing circuit (DSP), a field programmable gate arrays (FPGA), and an application specific integrated circuit (ASIC). Yet other examples are an embedded inference processing unit (EIPU) or an embedded inference processing circuit, an artificial intelligence (AI) accelerator processing circuit, a neural processing unit (NPU) or a neural processing circuit, a tensor processing unit (TPU) or a tensor processing circuit, a multiprocessing circuit, and so on. These multiple processing circuits execute a variety of types of machine learning (ML) data models to implement the Gen AI model and perform video processing steps. The ML data models include multiple trained data models that use machine learning techniques that rely on one of generative adversarial networks (GANs), diffusion models, a recurrent neural network (RNN) structure, a convolutional neural network (CNN) structure, a deep neural network (DNN) structure, and so forth.

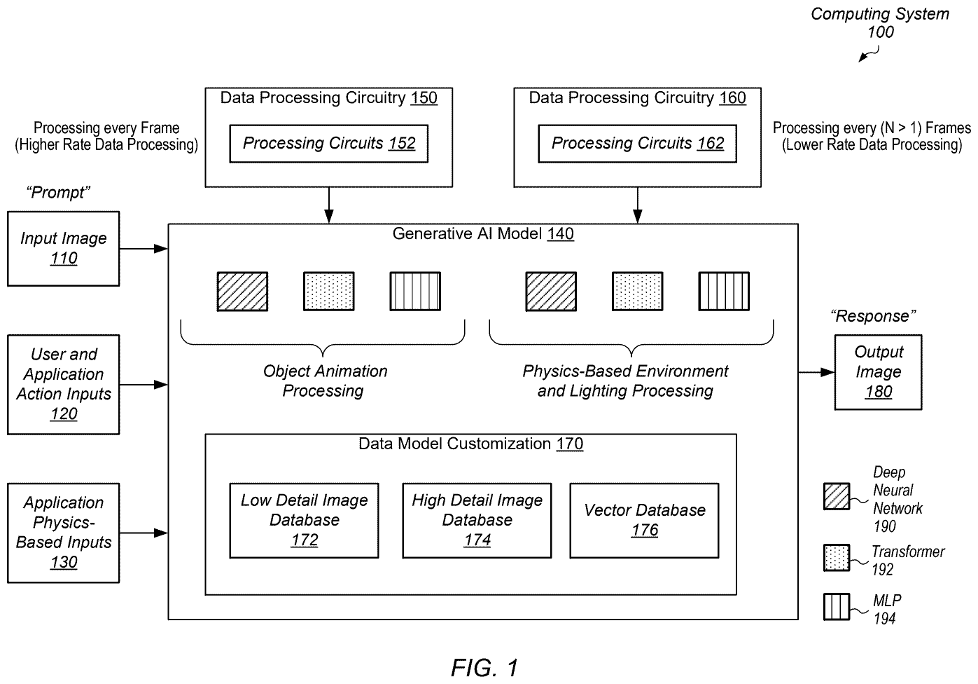

In various implementations, one or more of the multiple processing circuits execute a first subset of video processing tasks at a first data processing rate. When executing the first subset of video processing tasks, the processing circuits generate a first portion of the output image that includes one or more objects of the scene based on the input image data. The multiple processing circuits execute a second subset of video processing tasks at a second data processing rate less than the first data processing rate. When executing the second subset of video processing tasks, the processing circuits generate environmental visual effects, based on image data corresponding to a second scene prior to the first scene of the video sequence. In other words, the multiple processing circuits complete generation of the first portion of the output image over a first duration of time where the first duration of time is less than a second duration of time over which the multiple processing circuits complete generation of the second portion of the output image. Further details of these techniques for performing efficient video processing that provides visual fidelity with changes in lighting and animation details are provided in the following description of FIGS. 1-7.

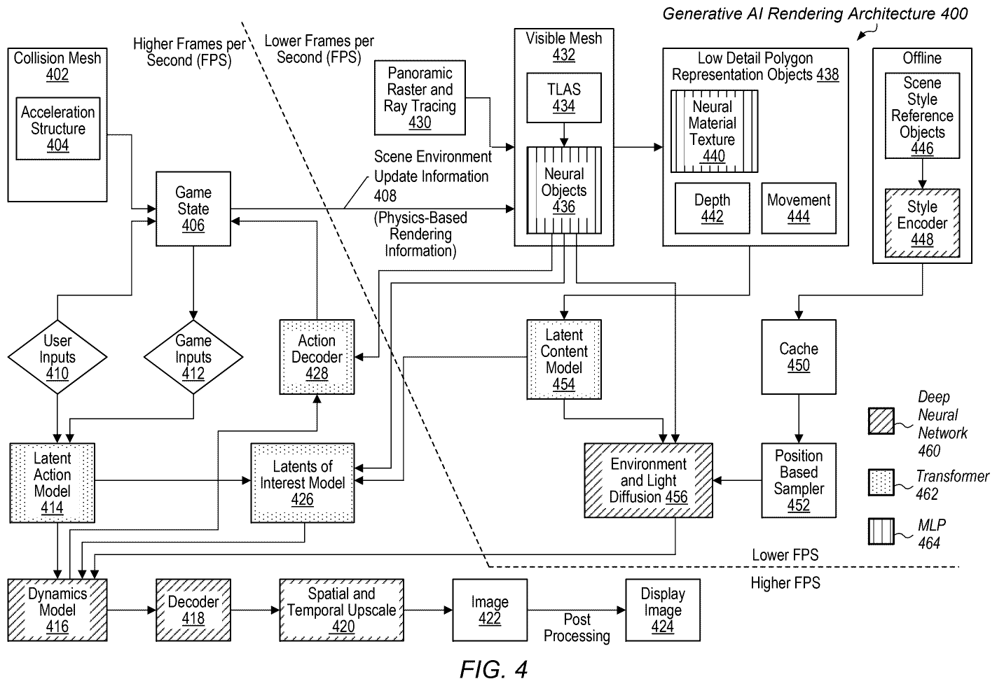

Turning now to FIG. 1, a generalized diagram is shown of a computing system 100 that performs efficient video processing that provides visual fidelity with changes in lighting and animation details. As shown, computing system 100 includes a generative artificial intelligence (Gen AI) model 140 that generates an output image, such as display image 180, based on a combination of the input image 110, user and application action inputs 120, and application physics-based inputs 130. The Gen AI model 140 is implemented by processing circuits 152 of data processing circuitry 150 and processing circuits 162 of data processing circuitry 160 executing a variety of types of machine learning (ML) data models according to a particular architecture. In some implementations, Gen AI model 140 utilizes the Gen AI rendering architecture 400 (of FIG. 4). During rendering of input image 110, data processing circuitry 150 and data processing circuitry 160 use parameters from data model customization 170. Copies of the multiple components of Gen AI model 140 are stored in one or more of a cache memory subsystem and a memory subsystem (not shown), which are accessed by data processing circuitry 150 and 160.

Input image 110 is representative of a scene of an input image of a video sequence that includes multiple scenes. The video processing application provides multiple input images of a video sequence, each with a scene. The video sequence includes animation as well as environmental visual effects portrayed across the scenes. For example, a user executes a video processing application that uses three-dimensional animation on the user's computing device. Examples of the user's computing device are a desktop computer, a laptop computer, a smartphone, a tablet computer, and so forth. The video processing application can be from one of multiple fields such as entertainment, medicine, business marketing, education, engineering, and so forth.

The video graphics application also provides, as inputs 120, user input information such as user controls that indicate movement or selections of menu options. Inputs 120 also includes application input information that indicates environment conditions such as amounts of wind blowing, rain, energy of water waves, movement of objects and direction, and so forth. Application physics-based inputs 130 includes indications of weather conditions for a scene depicting an outdoor image with snow, rain, sunshine, and so forth. Application physics-based inputs 130 includes indications of environmental visual effects such as lighting effects that include multi-bounce reflections, caustics such as patterns of light and color that occur due to light rays reflecting or refracting on a surface, complex physics such as foliage interaction with assets and air, and multi-phase flow such as multi-phase boundary phenomenon (e.g., fire, sea-spray, wave foam, wave break). Application physics-based inputs 130 includes indications of inputs used for physics-based rendering (PBR).

Processing circuits 152 includes a host processing circuit that executes instructions of the video graphics application and translates instructions to commands for other processing circuits. An example of the host processing circuit is a general-purpose processing circuit, such as a central processing unit (CPU). Examples of other processing circuits of processing circuits 152 and 162 are a graphics processing unit (GPU), a digital signal processing circuit (DSP), a field programmable gate arrays (FPGA), and an application specific integrated circuit (ASIC). Yet other examples are an embedded inference processing unit (EIPU) or an embedded inference processing circuit, an artificial intelligence (AI) accelerator processing circuit, a neural processing unit (NPU) or a neural processing circuit, a tensor processing unit (TPU) or a tensor processing circuit, a multiprocessing circuit, and so on.

In some implementations, data processing circuitry 150 performs and completes video processing tasks at a data processing rate of every frame and data processing circuitry 160 performs and completes video processing tasks at a data processing rate of every N frames where N is a positive, non-zero integer greater than one. In other words, data processing circuitry 150 completes generation of a first portion of output image 180 over a first duration of time where the first duration of time is less than a second duration of time over which the data processing circuitry 160 completes generation of a second portion of output image 180. Data processing circuitry 150 completes video processing tasks at a first frames per second (FPS) rate that is greater than a second frames per second (FPS) rate at which data processing circuitry 160 completes video processing tasks. Therefore, data processing circuitry 150 has a higher data processing demand placed on it than data processing circuitry 160.

In various implementations, data processing circuitry 150 performs video processing tasks directed to object animation updates, whereas data processing circuitry 160 performs video processing tasks directed to environmental visual effects updates. The first portion of output image 180 includes the one or more objects of a first scene based on the image data 110. The first portion includes data that indicates positions, points of view and animation of the one or more objects in the first scene. The second portion of output image 180 includes environmental visual effects based on image data corresponding to a second scene prior to the first scene of the video sequence. Examples of the environmental visual effects of the second portion of output image 180 are shadows caused by placement, textures and animation of objects in the second scene prior to the first scene of the video sequence. Other examples of the environmental visual effects of the second portion of output image 180 are patterns of light and color that occur due to light rays reflecting or refracting on a surface of an object in the scene. In some implementations, data processing circuitry 160 generates the indications of the environmental visual effects of the second portion of output image 180 based on a panoramic mode.

Processing circuits 152 and 162 execute a variety of types of machine learning (ML) data models to implement the Gen AI model 140 and perform video processing steps. The ML data models include multiple trained data models that use machine learning techniques that rely on one of generative adversarial networks (GANs), diffusion models, a recurrent neural network (RNN) structure, a convolutional neural network (CNN) structure, a deep neural network (DNN) structure, and so forth. Therefore, processing circuits 152 and 162 execute multiple types of ML data models, which are shown as being grouped into deep neural networks 190, transformers 192 and multilayer perceptrons (MLPs) 194. The differences between deep neural networks (DNNs) 190 and MLPs 194 are DNNs 190 typically have a greater number of hidden layers and more nodes per layer, DNNs 190 can have feedback loops, whereas MLPs 194 have feed-forward data movement in the hidden layers with no loops, DNNs 190 have longer training times, and DNNs 190 are typically executed on neural processing circuits or tensor processing circuits, whereas MLPs 194 are typically executed on GPUs.

Transformers 192 use a neural network structure to convert an input sequence of values into an output sequence of values by tracking relationships between components of the input sequence and tracking long term dependencies or relationships with prior input sequences. Transformers 192 utilize attention and self-attention mathematical techniques to track dependencies or relationships. In some implementations, the transformers 192 convert inputs to numerical representations referred to as “tokens.” In some implementations, each token is converted into a vector by a lookup operation of an embedding table. These vectors are encoded vectors. When data is transformed into numerical values, such as tokens, a variety of other mapping techniques can be used to map the tokens to encoded vectors, which can be referred to as “latent space vectors” or “latent vectors” or “embedding rows.” Tokenization and mapping cause the original data to be mapped from a higher-dimensional space to a lower-dimensional space while preserving the meaning of the original data. Examples of these other mapping techniques are the Principal Component Analysis (PCA) technique, the Singular Value Decomposition (SVD) technique, the Word2Vec technique, the t-SNE (t-Distributed Stochastic Neighbor Embedding) technique, the UMAP (Uniform Manifold Approximation and Projection) technique, and so forth. Additionally, ML data models such as encoder neural networks and Autoencoders can be used.

Although DNNs 190, transformers 192, and MLPs 194 are shown as classes or categories of ML data models that can rely on a variety of types of neural network structures and be used by processing circuits 152 and 162 to implement the Gen AI model 140, in other implementations, additional categories are used or other categories replace these categories. For example, a variety of types of encoder neural networks and decoder neural networks can be used by Gen AI model 140.

The Gen AI model 140 utilizes low level of detail (LOD) objects of input image 110. As used herein, the terms “low” and “high” are merely intended to indicate one object has lower or higher detail than the other. In other words, these terms are intended to indicate relative levels of detail. The level of detail used for each of the low LOD object and the high LOD object can vary. The low detail image database 172 stores low detail polygon mesh representations of objects in the scene of the input image 110. This data in addition to inputs 120 and 130 are transferred from the host processing circuit of data processing circuitry 150 to other processing circuits of data processing circuitry 160 during real-time data transfer operations. The memory subsystem can handle the small amount of data being transferred in real time.

The high detail image database 174 stores both the images of artist interpretation of scene objects and the corresponding tokens and latent space vectors. Therefore, the high detail image database 174 stores the neural representation of one or more objects with pre-encoded style characteristics. The information in the high detail image database 174 is the same as information stored in cache 450 (of FIG. 4). Vector database 176 stores encoded vectors, such as latent space vectors, corresponding to a variety of types of information to be input to ML data models while rending the input image 110.

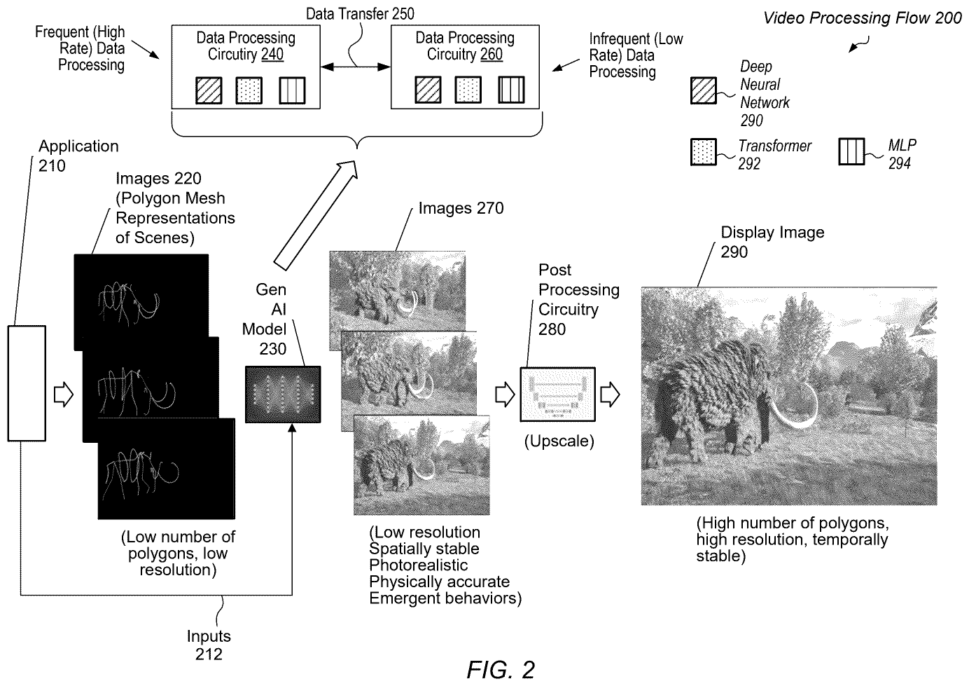

Turning now to FIG. 2, a generalized diagram is shown of a video processing flow 200 that performs efficient video processing that provides visual fidelity with changes in lighting and animation details. In the illustrated implementation, video processing flow 200 includes the video graphics application 210 providing input image data that include images 220 received by the generative artificial intelligence (Gen AI) model 230. Gen AI model 230 also receives inputs 212 from application 210 and generates images 270. Post-processing circuitry 280 generates a display image 290 for each of the images 270. The display image 290 is an output image that is converted to a video frame. In various implementations, display image 290 is based on at least two scenes of multiple scenes of a video sequence. Animation effects to be used for display image 290 are based on a first scene provided by an input image of images 220 in the video sequence. However, environment and lighting effects are based on a second scene prior to the first scene in the video sequence. In other words, the second scene is older than the first scene in the sequence. In an implementation, the first scene is scene G (e.g., scene 100 where G is 100) in the video sequence. Here, “G” is a positive integer. The animation effects of the corresponding display image 290 are based on scene 100. However, the environment and lighting effects of the corresponding display image 290 are based on scene 98, which is scene G-H−1 where H is a positive, non-zero integer (e.g., scene 98 where H is 3).

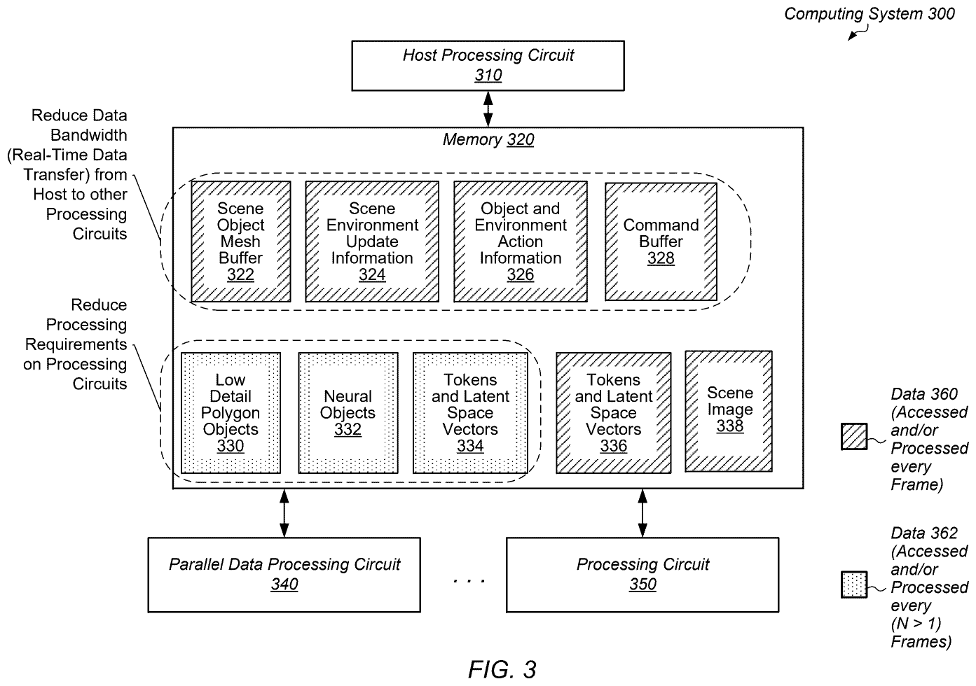

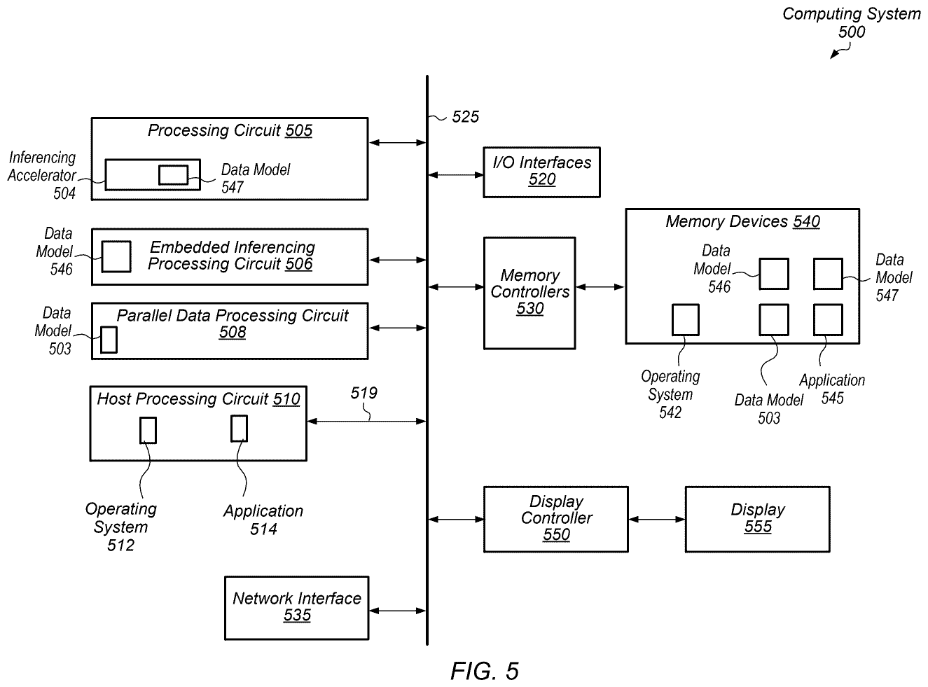

The Gen AI model 230 is implemented by processing circuits (not shown) of data processing circuitry 240 and data processing circuitry 260 executing a variety of types of machine learning (ML) data models according to a particular architecture. In some implementations, Gen AI model 230 utilizes the Gen AI rendering architecture 400 (of FIG. 4). The types of processing circuits and the functionality of the processing circuits are the same as those for processing circuits 152 and 162 (of FIG. 1), host processing circuit 310 and parallel data processing circuit 340 and processing circuit 350 (of FIG. 3), and processing circuits 505, 506, 508 and 510 (of FIG. 5).

In various implementations, data processing circuitry 240 and 260 have the same functionality as data processing circuitry 150 and 160 (of FIG. 1). Therefore, data processing circuitry 240 complete generation of a first portion of display image 290 over a first duration of time, wherein the first duration of time is less than a second duration of time over which data processing circuitry 260 completes generation of a second portion of display image 290. In other implementations, data processing circuitry 240 performs and completes video processing tasks at a data processing rate of every frame and data processing circuitry 260 performs and completes video processing tasks at a data processing rate of every N frames where N is a positive, non-zero integer greater than one. Therefore, data processing circuitry 240 has a higher data processing demand placed on it than data processing circuitry 260. Data processing circuitry 240 completes video processing tasks at a first frames per second (FPS) rate that is greater than a second frames per second (FPS) rate at which data processing circuitry 260 completes video processing tasks.

In various implementations, data processing circuitry 240 performs video processing tasks directed to object animation updates, whereas data processing circuitry 160 performs video processing tasks directed to environmental visual effects updates. The first portion of display image 290 includes one or more objects of a first scene based on the input image data of one of images 220. The first portion includes data that indicates positions, points of view and animation of the one or more objects in the first scene. The second portion of display image 290 includes environmental visual effects based on image data corresponding to a second scene prior to the first scene of the video sequence. Examples of the environmental visual effects of the second portion of display image 290 are shadows caused by placement, textures and animation of objects in the second scene prior to the first scene of the video sequence. Other examples of the environmental visual effects of the second portion of display image 290 are patterns of light and color that occur due to light rays reflecting or refracting on the surface of an object in the scene. In some implementations, data processing circuitry 260 generates the indications of the environmental visual effects of the second portion of display image 290 based on a panoramic mode.

In some implementations, data processing circuitry 240 and 260 implement a variety of ML data models using the categories of DNNs 290, transformers 292, and MLPs 294. Examples of the ML data models, and neural network structures used in these categories are the same examples used for DNNs 190, transformers 192, and MLPs 194 (of FIG. 1). In some implementations, inputs 212 have the same information as inputs 120 and 130 (of FIG. 1). The data processing circuitry 240 stores low detail polygon mesh representations of objects in the scenes of images 220. This data in addition to inputs 212 are transferred from the host processing circuit of data processing circuitry 240 to other processing circuits of data processing circuitry 260 during real-time data transfer operations 250. The memory subsystem can handle the small amount of data being transferred by data transfer 250 in real time. This data is the same as the information provided in buffer 322, information 324 and 326, and buffer 328 (of FIG. 3). The Gen AI model 230 provides images 270, which are processed by post processing circuitry 280 to provide the display image 290.

Referring to FIG. 3, a generalized diagram is shown of a computing system 300 that performs efficient video processing that provides visual fidelity with changes in lighting and animation details. In various implementations, computing system 300 includes host processing circuit 310, parallel data processing circuit 340 and processing circuit 350 accessing memory 320. Although three processing circuits are shown, in other implementations, another number of processing circuits are used based on design requirements. In an implementation, host processing circuit 310 is a general-purpose processing circuit, such as a central processing unit (CPU), and includes multiple general-purpose processor cores, each with one or more general-purpose pipelines that execute instructions of a particular instruction set architecture (ISA). Examples of parallel data processing circuit 340 are a graphics processing unit (GPU), a digital signal processing circuit (DSP), a field programmable gate arrays (FPGA), an application specific integrated circuit (ASIC), and so forth. Examples of processing circuit 350 are an embedded inference processing unit (EIPU) or an embedded inference processing circuit, an artificial intelligence (AI) accelerator processing circuit, a neural processing unit (NPU) or a neural processing circuit, a tensor processing unit (TPU) or a tensor processing circuit, a multiprocessing circuit, and so on.

In various implementations, processing circuits 310, 340 and 350 implement a Gen AI model for video processing by executing a variety of types of machine learning (ML) data models according to a particular architecture. In some implementations, the Gen AI model utilizes the Gen AI rendering architecture 400 (of FIG. 4). Although a single memory 320 is shown, in other implementations, the data storage of memory 320 is distributed across multiple levels of a cache memory subsystem, a system memory, local memories of processing circuits, and so on. As shown, memory 320 stores a variety of types of data that is accessed and processed either every video frame, such as data 360, or accessed and processed every N video frames where N is a positive, non-zero integer greater than one, such as data 362.

Although particular types of data are shown as being stored in memory 320, it is possible and contemplated that in other implementations, other types of data are generated, accessed, and processed. As shown, the data stored in buffer 322, information 324 and 326, and buffer 328 are sent in real-time from the host processing circuit 310 to other processing circuits. The amount of this data is reduced to reduce the real-time demands of the data transfer. The scene object mesh buffer 322 stores low detail polygon mesh representations of objects in the scenes of images. In some implementations, scene object mesh buffer 322 stores the same type of data as low detail image database 172 (of FIG. 1). In an implementation, the low LOD objects use x, y, and z (or “X,” “Y,” and “Z”) coordinates of a 3D space, but two-dimensional (2D) triangles used as geometric primitives use u and v (or “U” and “V”) coordinates of a 2D space such as a UV texture space. When executing the instructions of a video processing application, the hardware of a processing circuit performs the steps of UV mapping, which includes generating a flat 2D representation of a 3D object with volume (or depth) and shape. Vertices grouped together form edges, edges grouped together form faces, faces grouped together form polygons, and polygons grouped together form surfaces (or meshes). The geometric information can be stored in a multi-node, tree-like data structure such as an acceleration structure (AS).

The scene environment update information 324 includes indications of inputs used for physics-based rendering (PBR). This information can include indications of environmental visual effects that include complex lighting effects such as multi-bounce reflections, caustics such as patterns of light and color that occur due to light rays reflecting or refracting on a surface, complex physics such as foliage interaction with assets and air, and multi-phase boundary phenomenon (e.g., fire, sea-spray, wave foam, wave break). Object and environment action information 326 includes indications of user action inputs and environment action inputs. The types of information for information 326 are the same as for inputs 120 (of FIG. 1) and inputs 212 (of FIG. 2).

In various implementations, the video graphics application is a computer program written by a developer in one of a variety of high-level programming languages such as such as C, C++, and Java and so on. The host processing circuit 310 begins processing the video graphics application and uses a library to translate function calls (kernels) in the application to commands particular to a piece of hardware such as one of the processing circuits 340 and 350. The real-time data transfer of the information in buffer 322, information 324 and 326, and buffer 328 being sent on a frame-by-frame basis is reduced. For example, high LOD object information is not being transferred.

Low detail polygon objects 330 include low LOD objects of objects in the scene and objects within the panoramic view of the scene but not directly in the scene being presented on the display device. Using low LOD objects reduces the performance demands and local memory demands of processing circuits 340 and 350. Neural objects 332 includes information from Path-Tracing (information like (d, s,e) color, (di, gi) lighting hints, surface information, and texture details. Block 436 also includes pose tokens that encode information of position, orientation, size, and type objects in the scene and around the scene in the panoramic view. Block 436 also includes information about parts of the objects such as the handle of a cup, finger positions, and so forth. Additional information includes control over movement, placement of limbs and fingers, and so forth.

Token and latent space vectors 334 includes tokens and encoded vectors used by processing circuits 340 and 350 when executing a variety of ML data models that include adding high fidelity visual information to objects every (N>1) frames. These ML data models, and these video processing steps are performed on the right half of the dashed line of architecture 400 (of FIG. 4). The information stored in blocks 330, 332 and 334 and accessed or processed every (N>1) frames reduces the processing demands on processing circuits 340 and 350. Token and latent space vectors 336 includes tokens and encoded vectors used by processing circuits 340 and 350 when executing ML data models and video processing steps are performed on the left half of the dashed line of architecture 400 (of FIG. 4). This information in token and latent space vectors 336 is used to support updates occurring every frame. Scene image 338 is the image to send to post-processing.

Referring to FIG. 4, a generalized diagram is shown of a generative artificial intelligence rendering architecture 400 that performs efficient video processing that provides visual fidelity with changes in lighting and animation details. As shown, the generative artificial intelligence (Gen AI) rendering architecture 400 includes a variety of types of machine learning (ML) data models arranged in a particular manner. The ML data models include a variety of types of deep neural networks 460, transformers 462 and multilayer perceptrons (MLPs) 464. Examples of the ML data models and neural network structures used in these categories are the same examples used for DNNs 190, transformers 192, and MLPs 194 (of FIG. 1) and DNNs 290, transformers 292, and MLPs 294 (of FIG. 2). The hardware of processing circuits used to execute components of Gen AI rendering architecture 400 are not shown for ease of illustration. However, examples of these processing circuits are processing circuits 152 and 162 (of FIG. 1), data processing circuitry 240 and data processing circuitry 260 (of FIG. 2), host processing circuit 310 and parallel data processing circuit 340 and processing circuit 350 (of FIG. 3), and processing circuits 505, 506, 508 and 510 (of FIG. 5).

As shown by the dashed line, the left portion of Gen AI rendering architecture 400 (or architecture 400) completes video processing tasks at a first frames per second (FPS) rate that is greater than a second frames per second (FPS) rate at which the right portion of architecture 400 completes video processing tasks. In some implementations, the left portion of architecture 400 includes processing a first subset of video processing tasks at a data processing rate of every frame, whereas the right portion of architecture 400 includes processing a second subset of video processing tasks at a data processing rate less than processing each video frame. Rather, the right portion of architecture 400 processes the second subset of video processing tasks at a data processing rate of every N frames where N is a positive, non-zero integer greater than one. Therefore, the processing demands of the corresponding processing circuits is reduced for the right portion of architecture 400.

For purposes of discussion, the blocks of architecture 400 are shown in a particular order with particular connections to other blocks. However, in other implementations, some blocks are relocated, some blocks are removed, additional blocks are added, and other connections are used. As shown, collision mesh block 402 includes low detail polygon mesh representations of objects in the scene of an input image. In some implementations, collision mesh block 402 stores the same type of data as low detail image database 172 (of FIG. 1) and scene object mesh buffer 322 (of FIG. 3). A first polygon count of the low level of detail (LOD) polygon mesh representation of the one or more objects is less than a second polygon count of a high LOD representation of the one or more objects of a corresponding output image. In various implementations, collision mesh block 402 stores an acceleration structure 404 (e.g., a bounding volume hierarchy) used to represent one or more objects of a scene of the input image. In some implementations, acceleration structure 404 is a multi-node tree data structure that includes geometry data arranged as a top-level acceleration structure and a bottom-level acceleration structure. The top-level acceleration structure stores references, such as a list, of the one or more objects of the scene of the input image. The bottom-level acceleration structure includes a polygon representation of each of the one or more objects. In various implementations, the polygon representation includes a mesh of triangles representing an object.

The host processing circuit maintains the game state 406, which includes state information of a video game application. Although an implementation using a video game application is being used to describe the blocks of architecture 400, it is possible and contemplated that architecture 400 is used for real-time video processing for displaying three-dimensional (3D) objects in a variety of video processing products for other fields such as biomedicine, urban planning, education, marketing, architecture, filmmaking, engineering, and so forth.

The game state block 406 receives user inputs 410, which includes user input information such as user controls that indicate movement or selections of menu options. The types of user information for user inputs 410 are the same as for inputs 120 (of FIG. 1) and inputs 212 (of FIG. 2). The latent action model block 414 converts user inputs 410 to latent space vectors, which are sent to the dynamics model block 416. The game state block 406 sends game inputs 412 to the dynamics model block 416 via the latent action model block 414 which performs conversion. The type of information of game inputs 412 includes application input information that indicate environment conditions such as amounts of wind blowing, rain, energy of water waves, movement of objects and direction (e.g., opposing players of a sports or other type of video game both in view and out of view within a panoramic environment, moving cars or horses or other transportation objects, overflying birds, etc.), and so forth.

The combination of blocks 414, 426 and 456 allows dynamics model 416 to update shadows or reflections of an object out of sight behind or above a character of the user based on the object moving within the panoramic environment of the character of the user. The shadows are due to multiple criteria such as placement of objects in the scene, textures of objects, animation or motion of the objects in the scene, and indications of environment information such as weather conditions that can include wind blowing, rain, energy of water waves, and so forth. The game inputs 412 are updated using the higher data processing rate, whereas the shape of the shadows or details of the reflections are updated using the lower data processing rate. For example, blocks 454 and 456, which are used for the updates of the shadows and reflections, utilize the lower data processing rate.

In an implementation, the higher data processing rate provides updates every frame, and with a frame per second (FPS) rate of 60 (60 FPS), the animation updates occur every 0.0167 seconds. In this implementation, the lower data processing rate is every 3 frames (N=3), or with an FPS of 20 FPS (60/3 FPS), and therefore, the lighting and environment updates occur every 0.050 seconds. Therefore, although blocks 416, 418 and 420 provide image 422 every frame at the higher data processing rate while using lighting and environment updates every 3 frames at the lower data processing rate, the human eye cannot distinguish the differences. Each of image 422 and display image 424 is an output video frame, which includes pixel data, rather than encoded vector representations of an input video frame. Additionally, by using the offline processing of the high detail image database 174 (of FIG. 1) stored in cache 450 (or another data structure) that includes the neural representation of one or more objects with pre-encoded style characteristics, architecture 400 provides high visual fidelity with panoramic details despite using the lower data processing rate for environment and lighting effects.

The scene environment update information 408 includes indications of inputs used for physics-based rendering (PBR). This information can include indications of environmental visual effects such as complex lighting effects that include multi-bounce reflections, caustics such as patterns of light and color that occur due to light rays reflecting or refracting on a surface, and complex physics such as foliage interaction with assets and air, multi-phase boundary phenomenon (e.g., fire, sea-spray, wave foam, wave break). The types of information for scene environment update information 408 is the same as for scene environment update information 324 (of FIG. 3). Block 430 performs raster and rendering operations in a panoramic mode. Block 430 also performs ray tracing operations. Therefore, block 430 participates in converting the low detail polygon mesh representation received from block 402 into a low detail image. Examples of the low detail image are images 220 (of FIG. 2). The output information is used with the information sent from the game state block 406 to provide low LOD objects of the objects in the scene and objects within the panoramic view of the scene but not directly in the scene being presented on the display device. For example, the visible mesh block 432 includes at least a top-level acceleration structure 434 (TLAS 434) for these objects.

Neural objects block 436 includes information from Path-Tracing (information like (d, s,e) color, (di, gi) lighting hints, surface information, and texture details. Block 436 also includes pose tokens that encode information of position, orientation, size, and type objects in the scene and around the scene in the panoramic view. Block 436 also includes information about parts of the objects such as the handle of a cup, finger positions, and so forth. Additional information includes control over movement, control over placement of limbs and fingers, and so forth. The information provided by block 436 is the same as neural objects 332 (of FIG. 3). In some implementations, block 432 has performed conversion steps offline and uses lookup tables and other techniques to access the conversion information and support a data processing rate of every N frames where N is a positive, non-zero integer greater than one.

Using information from block 432, the low detail polygon representation of objects block 438 (or block 438) includes low LOD objects such as objects in a low detail polygon mesh representation of a panoramic view of a scene of a video frame. Block 438 also includes motion vector information in block 444 and depth and distance information in block 442 and texture information from neural objects 440. Using this information, block 438 provides a low resolution, low LOD (low number of polygons of a mesh) panoramic view of the scene around an object and distances between objects and motion speeds and directions of objects are known.

The scene style reference objects block 446 includes images from artists of objects to use in scenes of the video frame. These images are the artist's interpretations of objects such as a cave, a building, a mountainside, a forest and so forth. Style encoder 448 converts the images to tokens and encoded vectors, such as latent space vectors, to provide the neural representation of one or more objects with pre-encoded style characteristics. Style encoder 448 can be trained with text conditioning and configurable latent space for themes such as a snowy outdoors environment, a nighttime environment, and so forth. Cache 450 stores the encoded vectors. These encoded vectors represent information such as the high detail image database 174 (of FIG. 1) that includes the neural representation of one or more objects with pre-encoded style characteristics. Cache 450 can be a level of a cache memory subsystem, a local memory of a processing circuit, or other data storage location. Based on information provided by game state 406, sampler 452 selects one of multiple versions of an image and the corresponding encoded vectors. Each of the position-based sampler 452 and the latent content model 454 send information to the environment and light diffusion model 456. The latent content model 454 receives information from block 438 and converts it to tokens and/or encoded vectors such as latent space vectors. The converted information allows the environment and light diffusion model 456 to have information it can process that indicates what the scene looks like and what rendering operations have been done.

In various implementations, the environment and light diffusion model 456 (or model 456) has been trained to generate images with high visual fidelity using a spatial super sampler. Training dataset for model 456 can be images from a game renderer as well as artist rendered images. Model 456 determines how the light should appear in the scene. Model 456 sends its output encoded vectors to dynamics model 416. Latent of interest model 426 generates encoded vectors, such as latent space vectors, that indicate, or otherwise, identify, objects of interest such as an opponent in a sports video game, objects being interacted with, and so forth. These encoded vectors can also be referred to as reference tokens. Therefore, latent of interest model 426 (or model 426) does not generate encoded vectors for each object in the scene, but rather generates encoded vectors of objects selected as objects of interest based on the input encoded vectors from the action model 414. The level of detail of the objects of interest is provided by the input values from block 438 (via model 454) and block 432. The latent space vectors (or reference tokens) from model 426 can be compressed using compressive transformer memory. Action decoder 428 extracts the action tokens from the output of dynamics model 416 and these action tokens are used to update game state 406. For example, these action tokens can be used to update a score or a number of fouls in a sports video game, update the health status of video game players, and so forth.

Dynamics model 416 converts video, action and reference tokens with guidance to the next image tokens. Dynamics model 416 sends the next image tokens to decoder 418, which converts the next image tokens to an image. Spatial and temporal upscale model 420 receives this image and generates image 422. The video tokens come from the environment and light diffusion model 456. The reference tokens are selected by the latent of interest model 426 and allow a direct connection to the objects to increase the coherence of the generated images. The previous tokens are used as input and modified based on cross-attention with the action tokens provided by latent action model block 414. The dynamics model 416 performs updates on a frame-by-frame basis. The output of dynamics model 416, the decoder model 418, and spatial and temporal upscale model 420 provides image 422. Video post processing steps are performed on image 422 to generate display image 424.

By using multiple ML data models (blocks 460, 462 and 464), architecture 400 allows training to occur for each individual ML data model separately instead of training a single, monolithic data model. Architecture 400 supports efficient data communication between the ML data models by passing tokens and latent space vectors between the ML data models, rather than images. For example, an image can include 512×512 pixels to be used for representing the image, whereas converted tokens can include 64×64 numerical values. Additionally, architecture 400 supports executing different portions of the Gen AI model at different data processing rates.

Turning now to FIG. 5, a generalized diagram is shown of a computing system 500 that performs efficient video processing that provides visual fidelity with changes in lighting and animation details. In various implementations, computing system 500 includes processing circuits 505, 506, 508 and 510. Additionally, computing system 500 includes input/output (I/O) interfaces 520, bus 525, network interface 535, memory controllers 530, memory devices 540, display controller 550, and display device 555. In other implementations, computing system 500 includes other components and/or computing system 500 is arranged differently. For example, power management circuitry, and phased locked loops (PLLs) or other clock generating circuitry are not shown for ease of illustration. In various implementations, the components of the computing system 500 are on the same die such as a system-on-a-chip (SOC). In other implementations, the components are individual dies in a system-in-package (SiP) or a multi-chip module (MCM). A variety of computing devices use the computing system 500 such as a desktop computer, a laptop computer, a server computer, a tablet computer, a smartphone, a gaming device, and so on.

In various implementations, host processing circuit 510 includes circuitry that executes instructions of operating system 512, which is a copy of the operating system 542 stored on memory devices 540. In an implementation, host processing circuit 510 is a general-purpose processing circuit, such as a central processing unit (CPU), and includes multiple general-purpose processor cores, each with one or more general-purpose pipelines that execute instructions of a particular instruction set architecture (ISA). A local memory (not shown) includes a local hierarchical cache memory subsystem of processing circuit 510. The local memory stores source data, intermediate results data, results data, and copies of data and instructions stored in memory devices 540. One or more of the processing circuits 505, 506 and 508 execute commands translated from instructions of the operating system 512. Processing circuit 510 is coupled to bus 525 via interface 519. In an implementation, interface 519 uses the communication protocol of a peripheral component interconnect (PCI) bus, a PCI-Extended (PCI-X), or a PCIE (PCI Express) bus. In some implementations, processing circuit 510 has a direct point-to-point (P5P) connection with processing circuit 508 that bypasses bus 525. Processing circuit 510 receives, via interface 519, copies of various data and instructions, such as a host operating system 512, one or more device drivers, one or more applications such as application 514, and/or other data and instructions. Application 514 is a copy of the application 545 stored on memory devices 540.

Processing circuits 506, 508 and 510 are representative of any number of processing circuits which are included in computing system 500. In various implementations, parallel data processing circuit 508 (or processing circuit 508) is a parallel data processing circuit with a highly parallel data microarchitecture. Examples of processing circuit 508 are a graphics processing unit (GPU), a digital signal processing circuit (DSP), a field programmable gate arrays (FPGA), an application specific integrated circuit (ASIC), and so forth. Processing circuit 508 can be a discrete device, such as a dedicated GPU (dGPU), or processing circuit 508 can be integrated in the same package as another processing circuit such as processing circuit 510. In such cases, processing circuit 508 is an integrated GPU (iGPU). Processing circuit 508 executes at least the machine learning data model 503.

In some implementations, processing circuit 506 is one of an embedded inference processing unit (EIPU) or an embedded inference processing circuit, an artificial intelligence (AI) accelerator processing circuit, an embedded neural processing unit (NPU) or an embedded neural processing circuit, a tensor processing unit (TPU) or a tensor processing circuit, a multiprocessing circuit, and so on. Processing circuit 506 executes at least the machine learning data model 546. In various implementations, processing circuit 505 includes a hardware accelerator such as an inferencing accelerator 504. In various implementations, inferencing accelerator 504 executes data model 547. In some implementations, application 514 is a video graphics application. To generate display images from video frames provided by application 514, in various implementations, the multiple processing circuits 505, 506 and 508 execute a variety of types of machine learning (ML) data models, such as at least data models 503, 546 and 547, to implement a generative artificial intelligence (Gen AI) model. The ML data models include multiple trained data models that use machine learning techniques that rely on one of generative adversarial networks (GANs), diffusion models, a recurrent neural network (RNN) structure, a convolutional neural network (CNN) structure, a deep neural network (DNN) structure, and so forth.

In various implementations, the multiple processing circuits 505, 506, 508 and 510 execute a subset of video rendering tasks using a data processing rate less than processing each video frame. Rather, one or more of the multiple processing circuits 505, 506 and 508 execute this subset of video rendering tasks at a data processing rate of every N frames where N is a positive, non-zero integer greater than one. Additionally, computing system 500 reduces the real-time data transfer from the host processing circuit 510 to one or more of processing circuits 505, 506 and 508. In various implementations, computing system 500 utilizes the generative artificial intelligence rendering architecture 400 (of FIG. 4) to reduce the real-time data transfer and to reduce the workload of one or more of the multiple processing circuits 505, 506 and 508 that generate vectors and other indicative data specifying lighting and animation changes to objects in a scene of a video frame.

In some implementations, computing system 500 utilizes a communication fabric (“fabric”), rather than the bus 525, for transferring requests, responses, and messages between the processing circuits 505 and 510, the I/O interfaces 520, the memory controllers 530, the network interface 535, and the display controller 550. When messages include requests for obtaining targeted data, the circuitry of interfaces within the components of computing system 500 translates target addresses of requested data. In some implementations, the bus 525, or a fabric, includes circuitry for supporting communication, data transmission, network protocols, address formats, interface signals and synchronous/asynchronous clock domain usage for routing data.

Memory controllers 530 are representative of any number and type of memory controllers accessible by processing circuits 505 and 510. While memory controllers 530 are shown as being separate from processing circuits 505 and 510, it should be understood that this merely represents one possible implementation. In other implementations, one of memory controllers 530 is embedded within one or more of processing circuits 505 and 510 or it is located on the same semiconductor die as one or more of processing circuits 505 and 510. Memory controllers 530 are coupled to any number and type of memory devices 540.

Memory devices 540 are representative of any number and type of memory devices. For example, the type of memory in memory devices 540 includes Dynamic Random Access Memory (DRAM), Static Random Access Memory (SRAM), NAND Flash memory, NOR flash memory, Ferroelectric Random Access Memory (FeRAM), or otherwise. Memory devices 540 store at least instructions of an operating system, one or more device drivers, and application. In some implementations, an application stored on memory devices 540 is a highly parallel data application such as a video graphics application, a shader application, or other. Copies of these instructions can be stored in a memory or cache device local to processing circuit 510 and/or processing circuit 505.

I/O interfaces 520 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB). Various types of peripheral devices (not shown) are coupled to I/O interfaces 520. Such peripheral devices include (but are not limited to) displays, keyboards, mice, printers, scanners, joysticks or other types of game controllers, media recording devices, external storage devices, and so forth. Network interface 535 receives and sends network messages across a network.

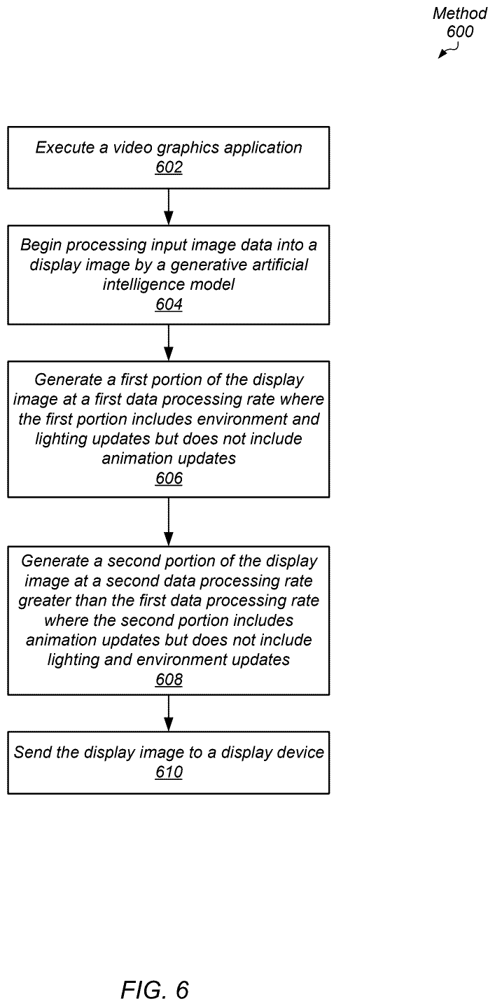

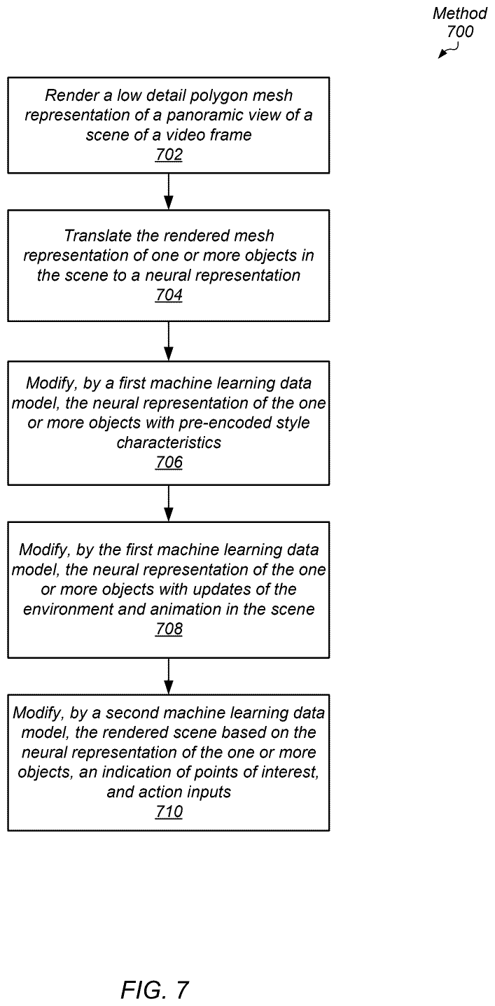

For the methods 600-700 (of FIGS. 6-7), a computing system includes multiple processing circuits. A host processing circuit of the multiple processing circuits is a general-purpose processing circuit, such as a central processing unit (CPU). Another processing circuit of the multiple processing circuits is a parallel data processing circuit with a highly parallel data microarchitecture. Examples of this processing circuit are a graphics processing unit (GPU), a digital signal processing circuit (DSP), a field programmable gate arrays (FPGA), and an application specific integrated circuit (ASIC). Yet other examples of the multiple processing circuits are an embedded inference processing unit (EIPU) or an embedded inference processing circuit, an artificial intelligence (AI) accelerator processing circuit, a neural processing unit (NPU) or a neural processing circuit, a tensor processing unit (TPU) or a tensor processing circuit, a multiprocessing circuit, and so on.

For the methods 600-700 (of FIGS. 6-7), the multiple processing circuits execute a variety of types of video graphics parallel data applications. To generate display images from video frames, in various implementations, the multiple processing circuits execute a variety of types of machine learning (ML) data models to implement a generative artificial intelligence (Gen AI) model. The ML data models include multiple trained data models that use machine learning techniques that rely on one of generative adversarial networks (GANs), diffusion models, a recurrent neural network (RNN) structure, a convolutional neural network (CNN) structure, a deep neural network (DNN) structure, and so forth. In various implementations, the multiple processing circuits execute a subset of video rendering tasks using a data processing rate less than processing each video frame. Rather, one or more of the multiple processing circuits execute this subset of video rendering tasks at a data processing rate of every N frames where N is a positive, non-zero integer greater than one. Additionally, the multiple processing circuits reduce the real-time data transfer from the host processing circuit to other processing circuits.

Referring to FIG. 6, a generalized diagram is shown of a method 600 for performing efficient video processing that provides visual fidelity with changes in lighting and animation details. For purposes of discussion, the steps in this implementation are shown in sequential order. However, in other implementations some steps occur in a different order than shown, some steps are performed concurrently, some steps are combined with other steps, and some steps are absent.

The host processing circuit of the computing system executes a video graphics application (block 602). In various implementations, the video graphics application is written by a developer in one of a variety of high-level programming languages such as such as C, C++, and Java and so on. The host processing circuit begins processing the video graphics application and a library uses a user mode driver (UMD) to translate function calls in the video graphics application to commands particular to a piece of hardware such as one of the other processing circuits. In various implementations, this other processing circuit is a parallel data processing circuit. The computing system begins processing input image data into a display image by utilizing a generative artificial intelligence model (block 604). To do so, the host processing circuit sends commands and pointers corresponding to data to process to one or more of the other processing circuits. In some implementations, the generative artificial intelligence model (Gen AI) model uses multiple ML data models arranged in a manner as shown earlier for architecture 400 (of FIG. 4). The display image is later converted to an output video frame based on two different scenes of a video sequence. Animation effects to be used for the output video frame are based on the scene that has processing begun in block 604. However, environment and lighting effects are based on another prior scene that is older in the video sequence that had to have processing begun earlier. In an implementation, in block 604, processing has begun for scene G (e.g., scene 100 where G is 100) in the sequence of video frames. Here, “G” is a positive integer. The animation effects of the output video frame are based on scene G. However, the environment and lighting effects of the output video frame are based on scene G-H−1 where H is a positive, non-zero integer (e.g., scene 98 where H is 3).

The Gen AI model converts a variety of input image data from the video processing application to latent space vectors and any other encoded vectors to provide compressed representations of the scene characteristics. The Gen AI model generates the first portion of the display image at a first data processing rate where the first portion includes lighting and environment updates but does not include animation updates (block 606). This first portion is based on a prior scene that is older in a video sequence of video frames that had processing begun earlier. In an implementation, this older scene is scene 98 as described in the earlier example. The Gen AI model generates a second portion of the display image at a second data processing rate greater than the first data processing rate where the second portion includes animation updates but does not include lighting and environment updates (block 608). This second portion is based on the current scene. In an implementation, this scene is scene 100 as described in the earlier example.

As described earlier, in other implementations some steps occur in a different order than shown. For example, the steps performed in block 608 can occur prior to or concurrently with the steps performed in block 606. However, in any case, the first portion that includes the lighting and environment updates is generated at a lower data processing rate than the data processing rate used to generate the second portion that includes the animation updates. In an implementation, one or more processing circuits execute a subset of video processing tasks to generate the first portion that includes the lighting and environment updates at a data processing rate of every N frames where N is a positive, non-zero integer greater than one. The one or more processing circuits execute another subset of video processing tasks to generate the second portion that includes the animation updates at a data processing rate of every frame. The Gen AI model converts encoded vectors to pixel data to provide the output video frame, which is used as the display image. The Gen AI model sends the display image to a display device (block 610).

Turning now to FIG. 7, a generalized diagram is shown of a method 700 for performing efficient video processing that provides visual fidelity with changes in lighting and animation details. The computing system used for implementing method 700 was described earlier prior to the description of method 600 (of FIG. 6). The Gen AI model renders a low detail polygon mesh representation of a panoramic view of a scene of a video frame (block 702). The Gen AI model translates the rendered mesh representation of one or more objects in the scene to a neural representation (block 704). The Gen AI model modifies, by a first machine learning data model, the neural representation of the one or more objects with pre-encoded style characteristics (block 706). The Gen AI model modifies, by the first machine learning data model, the neural representation of the one or more objects with updates of the environment and animation in the scene (block 708). The Gen AI model modifies, by a second machine learning data model, the rendered scene based on the neural representation of the one or more objects, an indication of points of interest, and action inputs (block 710).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
receive image data comprising an identification of one or more objects in a first scene of a video sequence; and
generate an output image corresponding to the first scene, wherein the output image is produced via a generative artificial intelligence model configured to:
generate a first portion of the output image comprising the one or more objects, based at least in part on the image data; and
generate a second portion of the output image comprising environmental visual effects, based at least in part on image data corresponding to a second scene prior to the first scene of the video sequence.

2. The apparatus as recited in claim 1, wherein a first polygon count of a first representation of the one or more objects received by the generative artificial intelligence model is less than a second polygon count of a second representation of the one or more objects of the output image.

3. The apparatus as recited in claim 2, wherein the circuitry is configured to render the one or more objects at a lower resolution than a resolution used in the output image.

4. The apparatus as recited in claim 1, wherein the circuitry is configured to complete generation of the first portion of the output image over a first duration of time, wherein the first duration of time is less than a second duration of time over which the circuitry completes generation of the second portion of the output image.

5. The apparatus as recited in claim 4, wherein the environmental visual effects of the second portion of the output image comprise shadows caused by placement, textures and animation of objects in the second scene prior to the first scene of the video sequence.

6. The apparatus as recited in claim 4, wherein the circuitry is configured to generate indications of the environmental visual effects of the second portion of the output image based on a panoramic mode.

7. The apparatus as recited in claim 1, wherein the first portion of the output image comprises data that indicates positions, points of view and animation of the one or more objects in the first scene.

8. A method, comprising:
receiving, by circuitry of a plurality of processing circuits, image data comprising an identification of one or more objects in a first scene of a video sequence;
generating, by the circuitry, an output image corresponding to the first scene, wherein the output image is produced by the circuitry executing a generative artificial intelligence model that comprises:
generating, by the circuitry, a first portion of the output image comprising the one or more objects, based at least in part on the image data; and
generating, by the circuitry, a second portion of the output image comprising environmental visual effects, based at least in part on image data corresponding to a second scene prior to the first scene of the video sequence.

9. The method as recited in claim 8, wherein a first polygon count of a first representation of the one or more objects received by the generative artificial intelligence model is less than a second polygon count of a second representation of the one or more objects of the output image.

10. The method as recited in claim 9, further comprising rendering, by the circuitry, the one or more objects at a lower resolution than a resolution used in the output image.

11. The method as recited in claim 8, further comprising completing generation of the first portion of the output image, by the circuitry, over a first duration of time, wherein the first duration of time is less than a second duration of time over which the circuitry completes generation of the second portion of the output image.

12. The method as recited in claim 11, wherein the environmental visual effects of the second portion of the output image comprise shadows caused by placement, textures and animation of objects in the second scene prior to the first scene of the video sequence.

13. The method as recited in claim 11, further comprising generating, by the circuitry, indications of the environmental visual effects of the second portion of the output image based on a panoramic mode.

14. The method as recited in claim 8, wherein the first portion of the output image comprises data that indicates positions, points of view and animation of the one or more objects in the first scene.

15. A computing system comprising:
a memory comprising circuitry configured to store data of a video sequence; and
a plurality of processing circuits; and
wherein the plurality of processing circuits is configured to:
retrieve, from the memory, the data of the video sequence; and
generate, via a generative artificial intelligence model, a plurality of output images corresponding to a plurality of scenes of the video sequence, wherein at least one output image of the plurality of output images comprises:
one or more objects in a first scene of the plurality of scenes of the video sequence; and
environmental visual effects, based at least in part on image data corresponding to a second scene prior to the first scene of the plurality of scenes of the video sequence.

16. The computing system as recited in claim 15, wherein a first polygon count of a first representation of the one or more objects received by the generative artificial intelligence model is less than a second polygon count of a second representation of the one or more objects of the at least one output image.

17. The computing system as recited in claim 16, wherein the plurality of processing circuits is configured to render the one or more objects at a lower resolution than a resolution used in the at least one output image.

18. The computing system as recited in claim 15, wherein the plurality of processing circuits is configured to complete generation of a first portion of the at least one output image over a first duration of time, wherein the first duration of time is less than a second duration of time over which the circuitry completes generation of a second portion of the at least one output image comprising the environmental visual effects.

19. The computing system as recited in claim 18, wherein the environmental visual effects of the second portion of the at least one output image comprise patterns of light and color that occur due to light rays reflecting or refracting on a surface of an object in the second scene prior to the first scene of the video sequence.

20. The computing system as recited in claim 18, wherein the plurality of processing circuits is configured to generate indications of the environmental visual effects of the second portion of the at least one output image based on a panoramic mode.
